(19) United States
(12) Patent Application Publication
(10) Pub. No.: US 2013/0191184 A1
(43) Pub. Date: Jul. 25, 2013

(54) Technique To Model Business Asset State Changes In Component Business Modeling

(71) Applicants: Vijaya Sampath, Bangalore (IN); Rishi Sundarajan Balaji, Hyderabad (IN)

(72) Inventors: Vijaya Sampath, Bangalore (IN); Rishi Sundarajan Balaji, Hyderabad (IN)

(73) Assignee: INTERNATIONAL BUSINESS MACHINES CORPORATION, Armonk, NY (US)

(21) Appl. No.: 13/356,697

(22) Filed: Jan. 24, 2012

(51) Int. Cl. G06Q 10/06

(52) U.S. Cl. 705/7.37; 705/7.36

(57) ABSTRACT

Component Business Model (“CBM”) software that can generate and maintain a CBM of an enterprise, with the CBM software including a state change identification module and a create state diagram module. The state change identification module identifies state changes in a Business Asset of the CBM. The create state diagram module creates a state diagram for the Business Asset based upon the changes identified by the state change identification module. In some embodiments, the Business Assets of the CBM for which state diagrams are created will be the predominant assets of Participating Business Components that are involved in a Business Scenario.

### BACKGROUND OF THE INVENTION

1. Field of the Invention

The present invention relates to component business modeling (CBM) and more particularly to CBM techniques that can be used to help identify opportunities for innovation and improvement.

2. Description of the Related Art

Component Business Model (CBM) is a computer technique developed to model and analyze an enterprise, using computers running CBM software. CBM is a logical representation or map of “business components” (or, simply, “components” or “parts” or “building blocks”). At least in some cases, the CBM can be effectively presented on a single page. The CBM analysis may include: (i) a determination of the alignment of enterprise strategy with the organization's capabilities and investments; (ii) identification of redundant or overlapping business capabilities; (iii) comparison of sourcing options for the different components (buy or build); (iv) prioritization of transformation options; and/or (v) creation of a unified roadmap after mergers or acquisitions.

In a typical CBM presentation, the visual representation of the model, created by the CBM software, is organized as “business components” along columns and “operational levels” along rows. The business components generally correspond to large business areas with characteristic skills, IT capabilities and/or characteristic processes. In a typical CBM, the three operational levels are “Direct,” “Control” and “Perform/Execute” (the terms “execute” and “perform” are used interchangeably in this document). These levels separate strategic decisions (Direct), management checks (Control), and business actions (Perform/Execute) on business competencies.

Some CBM-related terminology will now be defined:

(a) a Business Component is a portion of the CBM corresponding to a large area of the business(es) of the enterprise that: (i) has characteristic skills, information technology (“IT”) capabilities and/or characteristic processes, and (ii) has the potential to operate semi-independently, as a separate company, or as part of another company;

(b) a Business Scenario is a portion of the CBM that represents a collaboration of Business Components;

(c) a Business Asset is an economic resource acquired, augmented or generated, that produces distinct value in the commercial world of business interactions; a Business Asset can be tangible or intangible; examples of Business Assets are work force, intellectual property/know how, servicing capacity, distribution capacity, customer & stakeholder relationships, finances, building & equipment and products & services.

When a Business Scenario occurs, each Business Component involved in the collaboration of the Business Scenario will generally include one or more predominant Business Assets. Ideally, the various Business Assets of the different Business Components in the collaboration can be aggregated in order to perform all of the various activities that may be required or desired by the parties in control of the Business Scenario. If a specific asset is involved with (for example, controlled by) a specific Business Component, the changes to that specific asset caused by that specific Business Component may be presented to a CBM user.

### BRIEF SUMMARY OF THE INVENTION

The present invention recognizes that there is a need for a CBM with a consolidated view of the changes that a Business Asset goes through. Further, during IT implementation, the Business Scenario may translate to Business Processes, which Business Processes may be represented as state machines. When this happens, there would be no direct traceability between the state machines and the CBM that drives the solution. This because the CBM represents Business Scenarios as collaborations between Business Components and not as business asset state changes. This impacts the validation of the IT solution meeting the business requirements.

Some embodiments (see DEFINITIONS section) of the present invention(see DEFINITIONS section) are directed to one or more of the following aspects: (i) CBM that models and/or represents a Business Scenario as a set of Business Asset state changes; (ii) CBM that provides a consolidated view of the changes that a Business Asset goes through; and/or (iii) CBM that provides direct traceability between state machines and the CBM.

According to an aspect of the present invention, a CBM is generated and/or maintained by a computer running computer software, wherein Business Scenarios in the CBM are represented as a set of state machines. Each state machine represents the state changes undergone by the predominant Business Assets which are part of the Business Components participating in the scenario.

Various embodiments of the present invention may exhibit one or more of the following objects, features and/or advantages:

(i) improved business analysis (including improved analysis generally and improved analysis from a business asset perspective);

(ii) improved communication between and/or compatibility of CBM with state machines;

(iii) enables validation of a business scenario for completeness with respect to the component collaboration;

(iv) analyzing the scenario from a business asset perspective may lead to beneficial changes to Business Components that participate in the scenario and/or to the sequence of collaboration;

(v) facilitates traceability between the respective business and IT representations of a business scenario; and/or

(vi) the state diagrams associated with a business scenario can be mapped to the IT state machines which are designed during the technical design stage of the IT solution.

According to an aspect of the present invention, a process is performed by a computer system including a first processor set that runs machine readable instructions included in a CBM software. The process includes the following steps (not necessarily in the following order and without limitation as to whether the various steps overlap in time): (i) providing a CBM of an enterprise to the computer system and CBM software, with the CBM including: (a) a plurality of Business Components, and (b) a plurality of Business Assets, with each Business Asset being respectively associated with one or more of the Business Components; (ii) selecting, by the CBM software, a first Business Asset from among the plurality of Business Assets of the CBM of the enterprise; (iii) identifying, by the CBM software, changes in the state of the first Business Asset under a set of CBM modeling conditions; (iv) creating, by the CBM software, a first state diagram for the first Business Asset corresponding to the state changes identified at the identifying step; and (v) presenting, by the CBM software, the first state diagram in at least one of the two following ways: (a) generating a visual display of at least some meaningful portion of the first state diagram for the use of a human user, and/or (b) generating a data set of machine readable data corresponding to the first state diagram data.

According to a further aspect of the present invention, a computer program product is non-transiently stored on a software storage device. The product includes CBM software in the form of a plurality of machine readable instructions. The CBM software includes: a CBM storage module, a selection module, an identification module, a creation module and a presentation module. The CBM storage module is structured and/or programmed to receive a CBM of an enterprise, with the CBM including: (a) a plurality of Business Components, and (b) a plurality of Business Assets, with each Business Asset being respectively associated with one or more of the Business Components. The selection module is structured and/or programmed to select a first Business Asset from among the plurality of Business Assets of the CBM of the enterprise. The identification module is structured and/or programmed to identify changes in the state of the first Business Asset under a set of CBM modeling conditions. The creation module is structured and/or programmed to create a first state diagram for the first Business Asset corresponding to the state changes identified by the identification module. The presentation module is structured and/or programmed to present the first state diagram in at least one of the two following ways: (a) generating a visual display of at least some meaningful portion of the first state diagram for the use of a human user, and/or (b) generating a data set of machine readable data corresponding to the first state diagram data.

According to a further aspect of the present invention, CBM software is non-transiently stored on a software storage device. The CBM software is in the form of a plurality of machine readable instructions. The CBM software includes: a CBM storage module, a selection module, an identification module, a creation module and a presentation module. The CBM storage module is structured and/or programmed to receive a CBM of an enterprise, with the CBM including: (a) a plurality of Business Components, and (b) a plurality of Business Assets, with each Business Asset being respectively associated with one or more of the Business Components. The selection module is structured and/or programmed to select a first Business Asset from among the plurality of Business Assets of the CBM of the enterprise. The identification module is structured and/or programmed to identify changes in the state of the first Business Asset under a set of CBM modeling conditions. The creation module is structured and/or programmed to create a first state diagram for the first Business Asset corresponding to the state changes identified by the identification module. The presentation module is structured and/or programmed to present the first state diagram in at least one of the two following ways: (a) generating a visual display of at least some meaningful portion of the first state diagram for the use of a human user, and/or (b) generating a data set of machine readable data corresponding to the first state diagram data.

According to a further aspect of the present invention, a computer system includes: a software storage device, and a set of one or more processing unit(s). The software storage device has stored thereon CBM software and a CBM data set of machine readable data corresponding to a CBM of an enterprise. The set of processing unit(s) is structured and/or programmed to run the CBM software from the software storage device. The CBM software includes: a CBM storage module, a selection module, an identification module, a creation module and a presentation module. The CBM storage module is structured and/or programmed to receive a CBM of an enterprise, with the CBM including: (a) a plurality of Business Components, and (b) a plurality of Business Assets, with each Business Asset being respectively associated with one or more of the Business Components. The selection module is structured and/or programmed to select a first Business Asset from among the plurality of Business Assets of the CBM of the enterprise. The identification module is structured and/or programmed to identify changes in the state of the first Business Asset under a set of CBM modeling conditions. The creation module is structured and/or programmed to create a first state diagram for the first Business Asset corresponding to the state changes identified by the identification module. The presentation module is structured and/or programmed to present the first state diagram in at least one of the two following ways: (a) generating a visual display of at least some meaningful portion of the first state diagram for the use of a human user, and/or (b) generating a data set of machine readable data corresponding to the first state diagram data.

### BRIEF DESCRIPTION OF THE DRAWINGS

The present invention will be more fully understood and appreciated by reading the following Detailed Description in conjunction with the accompanying drawings, in which:

FIG. 1 is a screenshot view of a display generated by software according to the present invention;

FIG. 2 is a flowchart representing the first embodiment of a process according to the present invention;

FIG. 3 is a diagram of a portion of a first embodiment of a CBM model according to the present invention;

FIG. 4 is a diagram of another portion of the first embodiment CBM model;

FIG. 5 is a diagram of a portion of the first embodiment CBM model;

FIG. 6 is a diagram of another portion of the first embodiment CBM model;

FIG. 7 is a diagram of another portion of the first embodiment CBM model;

FIG. 8 is a diagram of another portion of the first embodiment CBM model;

FIG. 9 is a diagram of another portion of the first embodiment CBM model;

FIG. 10 is a diagram of another portion of the first embodiment CBM model; and

FIG. 11 is a schematic view of a first embodiment of a computer system according to the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction performance system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which perform via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which perform on the computer or other programmable apparatus provide processes for implementing the functions/acts specified in the flowchart and/or block diagram block or blocks. Before moving to a description of specific, non-limiting embodiments of the present invention, some of the subtler potential advantages will be identified and discussed.

According to business policies and customary practices, a Business Asset may have to pass through certain stages during its life cycle while the scenario is being performed. Validating such changes to the state of the Business Asset is not a straight-forward activity. By consolidating all the state changes that a Business Asset goes through in a Business Scenario, into a state diagram, a business analyst can validate the correctness and completeness of the business scenario and also the interaction points between the Business Components.

By representing a business scenario as a set state diagrams, IT Architects can ensure traceability between business and IT by mapping the state changes in the IT design to the state changes in the CBM. This will help in ensuring that the IT solution is in sync with the business' view of the specific scenario.

Due to any competitive pressures or regulatory compliance issues, if a state change is mandated, then the first place that captures this is in the Business Scenario, thereby ensuing process levels. Any changes are made to the Business Asset states and/or new Business

Assets are added to the Business Scenario, these variations will eventually need to be “IT-enabled.” This process becomes simpler when the changes are made at a Business Component level and then translated seamlessly into IT state machines. Hence, a technique to represent business scenarios as a set of business asset state changes, according to the present invention, is useful in facilitating “IT-enablement” of state changes mandated by competitive pressures, regulatory compliance issues or the like.

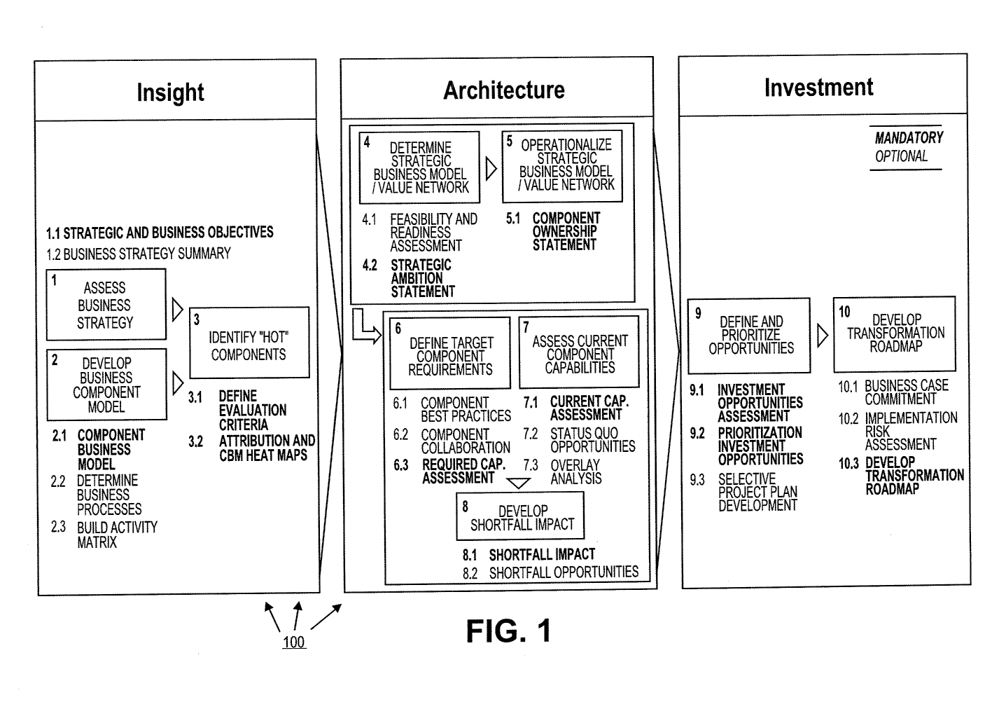

CBM is typically performed in three phases, Insight, Architecture and Investment. FIG. 1 at screen shot 100 shows a presentation of an example set of CBM deliverables having associated with it ten major CBM deliverables and including 24 mandatory and optional steps. As shown in FIG. 1, one can pick-and-choose from the CBM framework to deliver a customized way forward.

During the Architecture phase when the target components are to be defined in Step 6 of screenshot 100 based on Steps 4 & 5 there is a detailing of the Component Collaboration required and this is where a portion of the Business Scenario development takes place as part of the architectural building block. The components that form a part of the target capability are further elaborated and the Business Assets covering them are identified. Thereafter the state path identification is finalized leading into the required capability assessment and current capability assessment and overlay analysis.

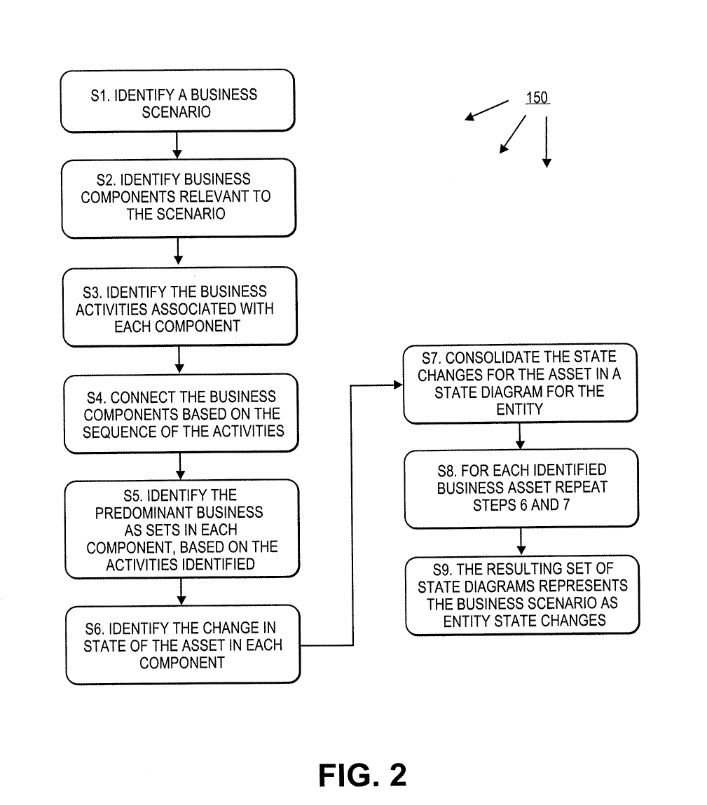

FIG. 2 is a flow chart representation 150 of the technique used to derive state machines from Business Scenarios in CBM, the technique including steps S1 to S9 as shown in FIG. 2. With reference to step S1, in process 150, the Business Scenario represents a series of high level activities that need to be performed, as a collaboration between Business Components, in order to accomplish a specific business objective. With reference to step S2, Business Scenarios can be identified based on the business problem that is being resolved. The high level activities that are defined by a Business Scenario generally are performed by one of more Participating Business Components. The Participating Business Components are preferably selected based on the functionality pertaining to the Business Scenario.

With reference to step S3, each Participating Business Component in CBM, has an associated set of activities. In this step S3, specific activities which are relevant to the Business Scenario are identified based on inputs from the subject matter experts.

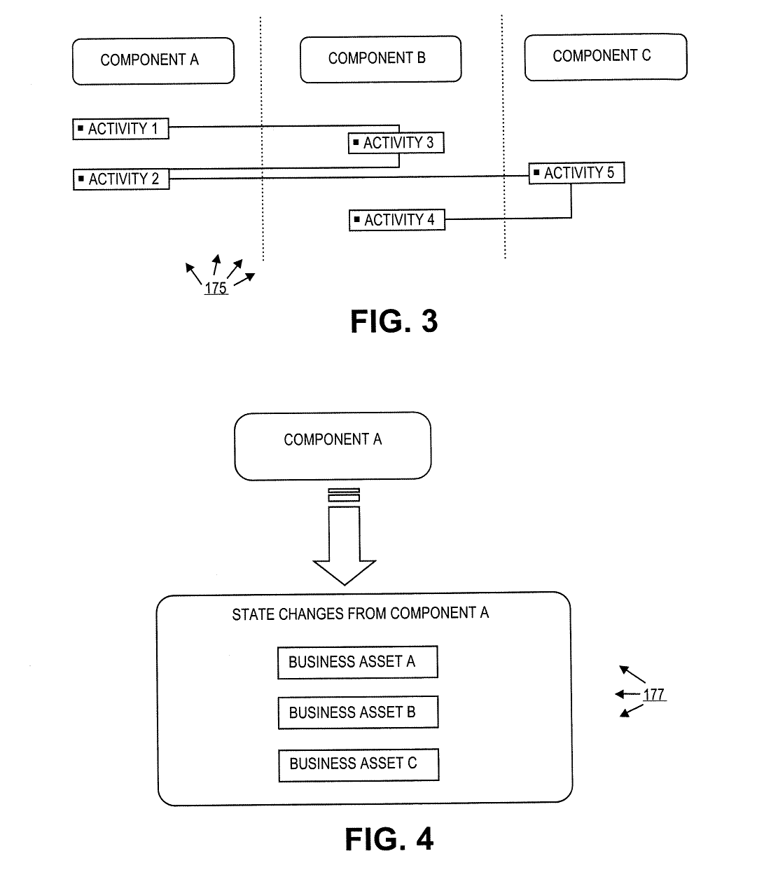

With reference to step S4, in this step, the components and activities which have been identified in steps 2 and 3 are arranged in a sequence as shown in FIG. 3. The activities across different components are connected based on the order in which they need to be performed. FIG. 3 shows a Business Scenario represented as a component collaboration.

With reference to step S5, for each component participating in the scenario, key Business Assets relevant to the activities performed by each Business Component are identified. The Business Assets, which are predominantly used in the component activities that were identified in step S3, are considered to be Key Business Assets. There may be other Business Assets which may be associated with the Business Component, but may not play a predominant role in the Business Scenario in context. Such “Non-Key Business Assets” are not considered to be the key ones. FIG. 4 shows the pictorial representation 177 of a Business Component mapped to its Business Assets. FIG. 4 shows the step of: Identify Business Assets.

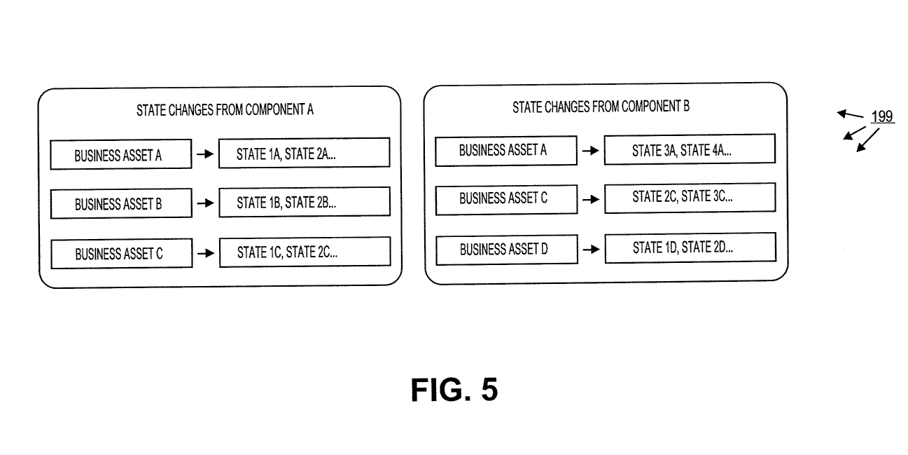

With reference to step S6 in process 150 (shown in FIG. 2), a Business Asset may have certain attributes which may define the state of the asset. When an activity is performed on the asset, these attributes may undergo changes, leading the asset to a different state. In this step S6, for each business asset identified in step S5, the state changes that the business asset undergoes in association with a component, are identified, as shown in diagram 199 of FIG. 5. FIG. 5 shows the step of: Identify State Changes for Business Assets.

With reference to step S7, the state changes of a specific business asset across the different components in the scenario are consolidated into a state diagram representation. The transition of a business asset from one state to the next is driven by the sequencing of the activities across the components in the business scenario. Each activity may cause a state change in a business asset, resulting in a transition.

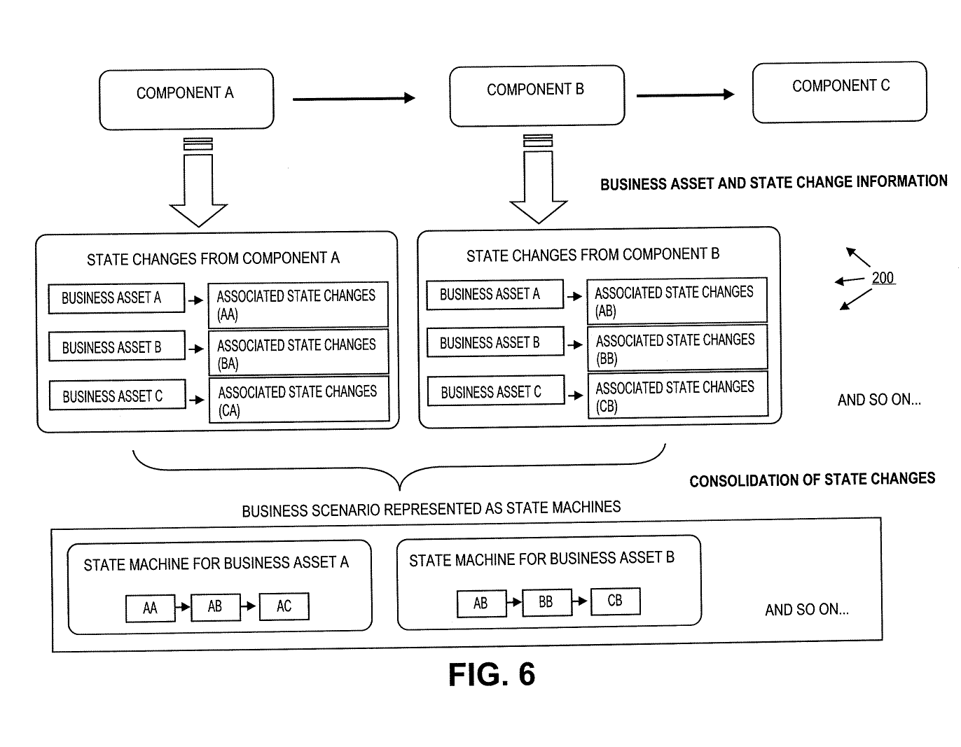

Steps S6 and S7 of process 150 are preferably repeated for all the Business Components in the Business Scenario, resulting in the set of state diagrams 200 representing the scenario, as shown in FIG. 6. FIG. 6 shows: Business Scenario Represented as State Diagrams.

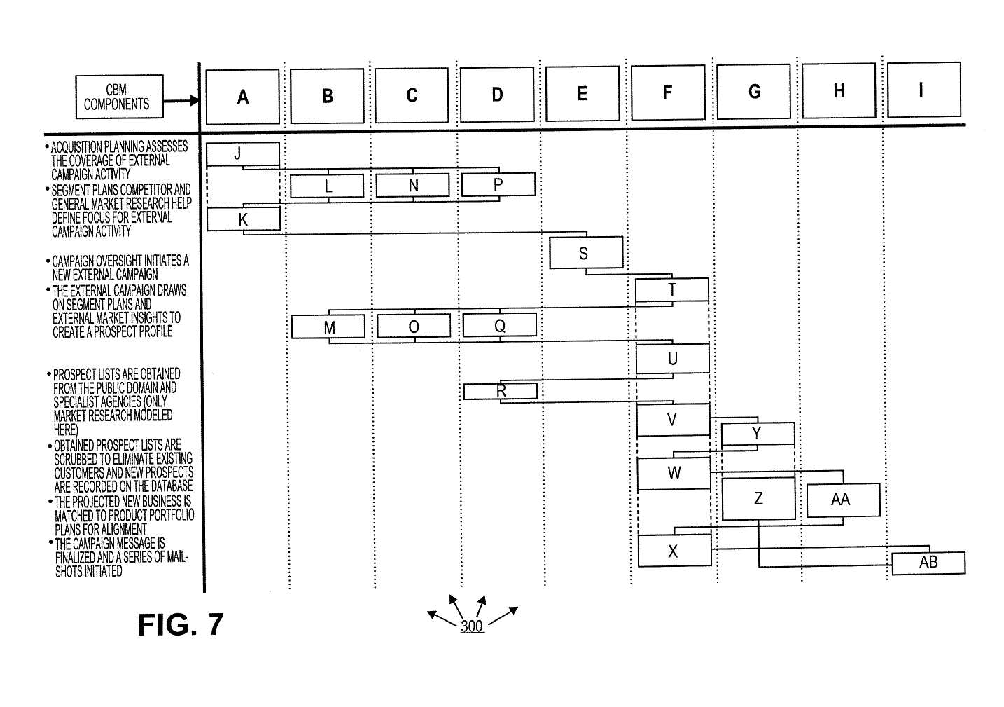

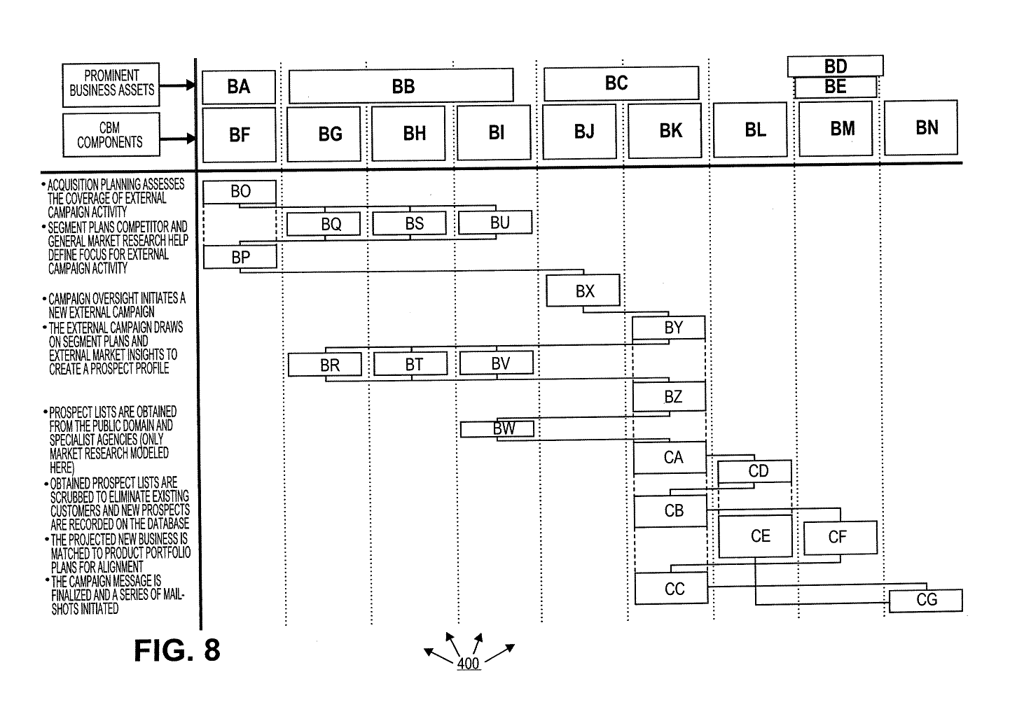

An example will now be discussed with reference to FIG. 7 (display 300) and FIG. 8 (display 400). The following is a decode key for the numbered boxes of FIGS. 6 and 7:

A: Acquisition external campaign Adv/Ext/Int

B: Segment Planning & Analysis

C: Market & Competitor Analysis

D: Market Research

E: Campaign Oversight Adv/Ext/Int

F :External Campaign Execution

G: Customer Reference Information

H: Product Portfolio Planning

I: Correspondence

J: Review external campaign activity

K: Direct focus for external campaigns

L: Provide segment profitability analysis

M: Provide segment profitability analysis

N: Provide competitor product insights

O: Provide competitor product insights

P: Provide customer product insights

Q: Provide customer product insights

R: Obtain prospect lists

S: Develop and perform external campaign task planning

T: Initiate development of external campaign

U: Specify target prospect profile and obtain prospect lists

V: Initiate cleansing of existing customer from prospect lists

W: Obtain agreement that campaign aligns with product strategy

X: Develop campaign message and final target list

Y: Eliminate existing customers from list

Z: Add new prospects to the data base including mailing address

AA: Confirm prospective new business alignments to produce strategy

AB: General mail-shot

BA: Business direction

BB: Classification-segment

BC: Event-campaign

BD: Condition

BE: Product

BF: Acquisition Planning Adv/Ext/Int

BG: Segment Planning & Analysis

BH: Market & Competitor Analysis

BI: Market Research

BJ: Campaign Oversight Adv/Ext/Int

BK: External Campaign Execution

BL: Customer reference information

BM: Product Portfolio Planning

BN: Correspondence

BO: Review External Campaign Activity

BP: Direction Focus For External Campaign

BQ: Provide Segment Profitability Analysis

BR: Provide Segment Profitability Analysis

BS: Provide Competitor Insights

BT: Provide Competitor Insights

BU: Provide Customer Segment Insights

BV: Provide Customer Segment Insights

BW: Obtain Prospect Lists

BX: Develop and Perform External Campaign Task Planning

BY: Initiate Development of External Campaign

BZ: Specify Target Prospect Profile and Obtain Target Lists

CA: Initial Cleansing of Existing Customer Form Prospect Lists

CB: Obtain Agreement That Campaign Aligns With Product Strategy

CC: Develop Campaign Message and Final Target Lists

CD: Eliminate Existing Customers From List

CE: Add New Prospects to the Data Base Including Mailing Address

CF: Confirm Prospective New Business Aligns to Product Strategy

CG: General Mail-Shot

An example (from Banking domain) demonstrating the technique:

1. Business Scenario Identification:

Business Scenario Name: External campaign management

Description:

In this scenario, acquisition planning assesses segment planning, competitor and general market research to develop external campaign activity needs. External prospect lists are scrubbed against internal customer lists and prospect names recorded as solicitation mail-shots are generated.

2. Business Component Identification: Business Components Involved in this scenario:

Acquisition Planning

Segment Planning and Analysis

Market and Competitor Analysis

Market Research

Campaign Oversight

External Campaign Execution

Customer Reference Information

Product Portfolio Planning

Correspondence

3,4. Business scenario represented as a sequence of component activities: the activities under each component, which are relevant to the current scenario are identified and represented as show in CBM display 300 of FIG. 7. FIG. 7 shows: Business scenario represented as a sequence of component activities.

5. Identification of predominant business assets: The predominant business assets which are manipulated by the activities listed under each of the business component participating in the scenario are:

Classification Segment

Event Campaign,

Condition, and

Product

There may be other assets which are used by these component activities, but may not be the predominant ones and hence are not listed here. The mapping of the predominant assets against the various business components is shown in CBM display 400 at set forth in FIG. 8. FIG. 8 shows the step of: Predominant business assets identified for each component.

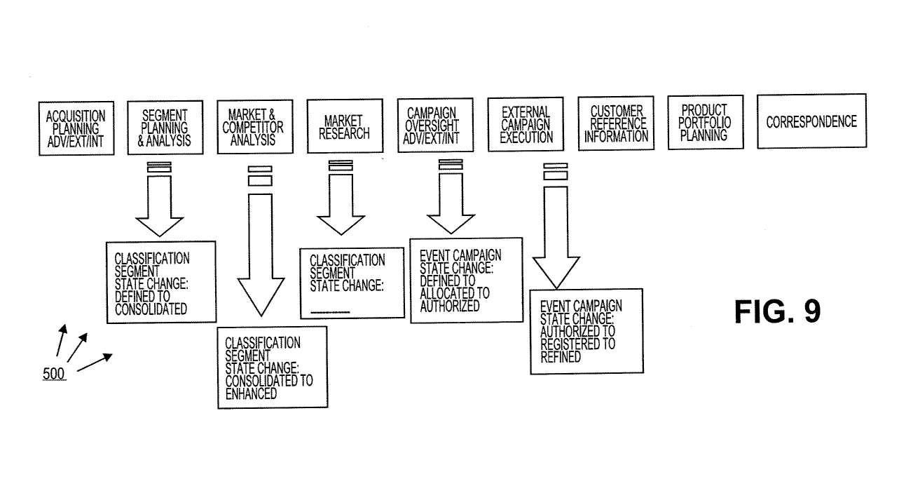

6. Identification of state changes: As a next step, the state change undergone by the predominant assets under each of the activities is identified. In the current scenario the Classification Segment and Event Campaign assets undergo state changes. The Product and Condition assets do not undergo significant state changes and hence are not used for the current analysis. Diagram 500 of FIG. 9 shows the state changes for each asset mapped under each of the Business Components. FIG. 9 shows the step of: State changes identified for predominant business assets.

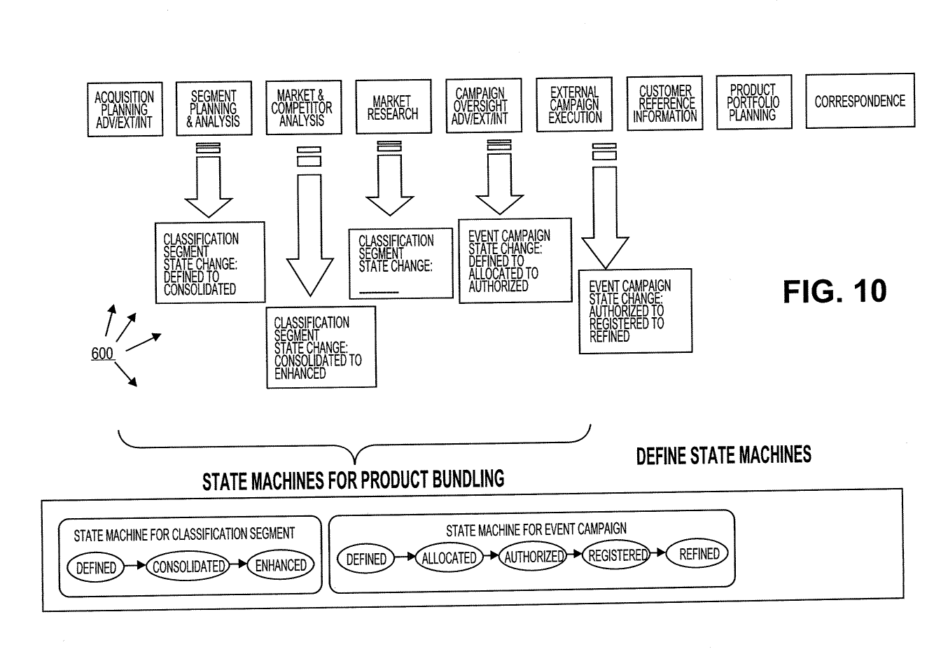

7. Consolidation of state changes: as a final step, the state changes that an asset undergoes in various activities spanning across different Business Components is consolidated into a state diagram for that asset. Diagram 600 of FIG. 10 shows the state diagrams for a Classification Segment and Event Campaign. FIG. 10 shows the step of: state changes consolidated into state diagrams

Tool enablement (IT-enablement) will now be discussed. The Component Business Modeler tool (hereafter referred to as the CBM Tool) is used to perform the activities that are typically performed during component business modeling. The CBM tool provides the necessary user interfaces and report generation functionality that is typically needed to perform CBM processes. The tool is available as a stand-alone application as well as in the form an Eclipse plug-in. IBM also provides industry specific CBM maps which are used as a starting point to perform CBM activities. In order to support the technique described in this disclosure, the CBM tool and the maps can be enhanced in several ways that will now be discussed.

One type of CBM enhancement is User Interface Enhancements. Specifically, the tool may be enhanced to provide additional user interfaces: to select relevant components for business scenario definition; to view and select activities, business assets and their states relevant to the business scenarios; to create new business assets and associate them to business activities; to create new states for a business asset; to view business scenario diagrams; and/or to view state diagrams. These interfaces may be incorporated into the existing user interface through additional user interface elements such as tabs, drop down menus.

Another type of CBM Enhancement is Functional Enhancements. Specifically, the CBM tool can be enhanced with additional functionality to: (i) select relevant business components for a business scenario, based on the textual description of the scenario; (ii) perform business asset creation (in addition to the pre-defined ones); and/or (iii) generate state diagrams based on the business asset state changes that have been associated with the activities.

Another type of CBM enhancement is Industry Content Enhancements. Specifically, the industry-specific CBM maps which IBM provides may be enhanced with the following content: pre-defined business assets; business asset to business component mapping; and/or pre-defined states which the business assets can be at any point of time. This content would provide business analysts with ready-to-use data that can be leveraged during the application of the technique described in this disclosure.

The following table summarizes the tooling support that can be built to implement the technique:

| Step | | |
|---|---|---|
| no. | Step Description | Tool Support Description |
| 1 | Identify a Business | NA |
| | Scenario | |
| 2 | Identify Business | Automated selection of relevant Business |
| | Components | Components for a Business Scenario, |
| | relevant to the | based on the textual description of |
| | scenario | the scenario. |
| | | User interface to manually select |
| | | relevant components for business |
| | | scenario definition |
| 3 | Identify the | User interface to view and select |
| | business activities | activities relevant to the Business |
| | associated with | Scenarios |
| | each component | |
| 4 | Connect the business | User interface to visualize a business |
| | components based on | scenario by connecting relevant |
| | the sequence of the | component activities. |
| | activities | |
| 5 | Identify the | pre-defined business assets in the |
| | predominant Business | industry-specific CBM map |
| | Assets in each | business asset to business component |
| | component, based on | mapping in the industry-specific |
| | the activities | CBM map |
| | identified | business asset creation (in addition |
| | | to the pre-defined ones) and mapping |
| | | them to components |
| 6 | For each identified | Not Applicable |
| | business asset | |
| | repeat steps 7 and 8 | |
| 7 | Identify the change | pre-defined states which the business |
| | in state of the | assets can be at any point of time, |
| | asset in each | in the industry-specific CBM map |
| | component | user interface and logic implementation |
| | | to define new states for the business asset |
| 8 | Consolidate the state | Automated generation of state diagrams |
| | changes for the asset | based on the sequence of the activities |
| | in a state diagram | and the Business Asset states assigned |
| | for the entity | to the different activities. |
| | | User interface to view state diagrams |

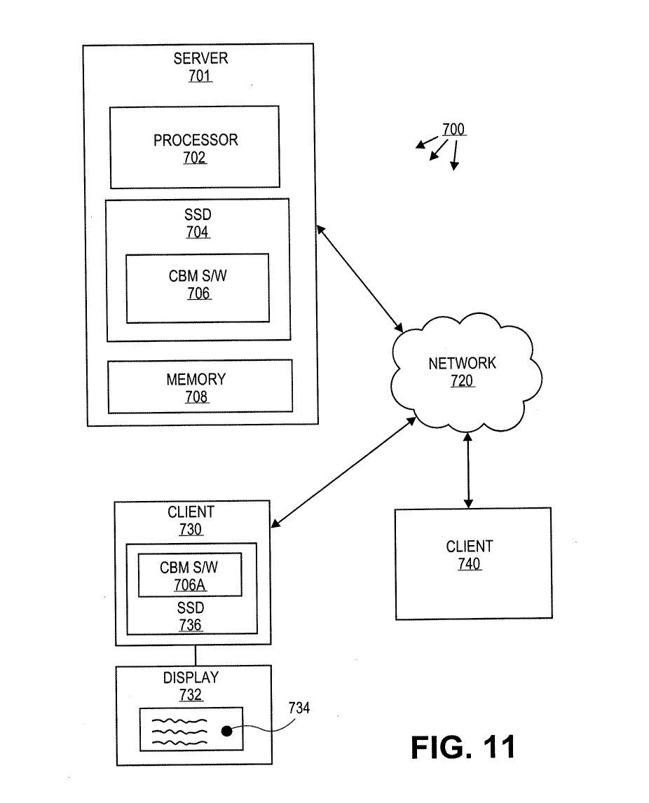

FIG. 11 shows computer system 700, including: server computer 701; data communication network 720; first client computer 730; first display 732; and second client computer 740. Server 701 includes: processing unit 702; software storage device (or “SSD,” see DEFINITIONS section) 704; and memory 708. SSD 704 includes CBM software 706. Like the server computer, the client computers have processors, long term data storage devices and memories (although these components are not necessarily separately shown for clarity of illustration reasons). First client 730 includes SSD 736, which includes and runs a first copy of CBM software 706a. Display 732 includes a visual representation generated by the first copy of the CBM software 706a as it runs on client computer 730. While client 730 runs the CBM software locally, client 740 runs the software remotely from one or more servers (such as server 701).

In the system of FIG. 11, the CBM software 706, 706a would include modules corresponding respectively to the steps of the flowchart of FIG. 2. These modules (not separately shown) would include machine readable instructions for performing the corresponding step of the flowchart of FIG. 2.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Definitions

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

1. A process, performed by a computer system including a non-transitory storage medium and a first processor set that runs machine readable instructions included in a component business model (“CBM”) software stored in said non-transitory storage medium, the process comprising the following steps:
providing a CBM of an enterprise to the computer system and CBM software, with the CBM including: (i) a plurality of business components, and (ii) a plurality of business assets, with each business asset being respectively associated with one or more of the business components;
selecting, by the CBM software, a first business asset from among the plurality of business assets of the CBM of the enterprise;
identifying, by the CBM software, any changes in the state of the first business asset resulting from a set of CBM modeling conditions;
creating, by the CBM software, a first state diagram for the first business asset corresponding to the state changes identified at the identifying step; and
presenting, by the CBM software, the first state diagram in at least one of the two following ways: (i) generating a visual display of at least a portion of the first state diagram for use by a human user, and (ii) generating a data set of machine readable data corresponding to the first state diagram data.

2. The process of claim 1 wherein:
the CBM further includes a first business scenario;
the first business scenario defines a set of one or more participating business component(s), from the plurality of business components, corresponding to the business component(s) that participate in the first business scenario; and
the identifying step is selective in that the only changes in the state of the first business asset that are identified are those changes in state associated with participating business component(s) and within a scope of the first business scenario.

3. The process of claim 1 wherein:
at the selecting step, a plurality of Assets selected business assets are selected; and
the identifying, creating and presenting steps are performed for each selected business asset.

4. The process of claim 3 wherein:
the CBM further includes a first business scenario;
the first business scenario defines a set of one or more participating business component(s), from the plurality of business components, corresponding to the business component(s) that participate in the first business scenario; and
flagging one or more dominant business asset(s) from among the business asset(s) of the participating business component(s);
wherein the identifying step is selective in that the only changes in the state of the first business asset that are identified are those changes in state associated with the flagged, dominant participating business components and within the scope of the first business scenario.

5. The process of claim 1 wherein, at the providing step, the CBM is provided in at least part by a human user through a user interface.

6. The process of claim 1 wherein, at the providing step, the CBM is provided in at least part by the receipt of machine readable data corresponding to the CBM by the CBM software.

7. A computer program product stored on a non-transitory software storage device, the product comprising CBM software in the form of a plurality of machine readable instructions, the CBM software comprising:
a CBM storage module programmed to receive a CBM of an enterprise, with the CBM including: (i) a plurality of business components, and (ii) a plurality of Business Assets business assets, with each business asset being respectively associated with one or more of the business components;
a selection module, programmed to select a first business asset from among the plurality of business assets of the CBM of the enterprise;
an identification module programmed to identify any changes in the state of the first business asset resulting from a set of CBM modeling conditions;
a creation module programmed to create a first state diagram for the first business asset corresponding to the state changes identified by the identification module; and
a presentation module programmed to present the first state diagram in at least one of the two following ways: (i) generating a visual display of at least a portion of the first state diagram use by a human user, and (ii) generating a data set of machine readable data corresponding to the first state diagram data.

8. The product of claim 7 wherein:
the CBM further includes a first business scenario;
the first business scenario defines a set of one or more participating business component(s), from the plurality of business components, corresponding to the business component(s) that participate in the first business scenario; and
the identification module is selective in that the only changes in the state of the first business asset that are identified are those changes in state associated with participating business component(s) and within a scope of the first business scenario.

9. The product of claim 7 wherein:
the selection module is further programmed to select a plurality of selected business assets;
the identification module is further structured and/or programmed to identify changes in the state of each selected business asset under a set of CBM modeling conditions;
the creation module is further structured and/or programmed to create a state diagram for each selected business asset respectively corresponding to the state changes for that selected business asset as identified by the identification module;
the presentation module is further programmed to present the state diagrams created by the creation module in at least one of the two following ways: (i) generating a visual display of at least a portion of the first state diagram for use by a human user, and (ii) generating a data set of machine readable data corresponding to the first state diagram data.

10. The product of claim 9 wherein:
the CBM software further includes a flagging module;
the CBM further includes a first business scenario;
the first business scenario defines a set of one or more participating business component(s), from the plurality of business components, corresponding to the business component(s) that participate in the first business scenario;
the flagging module is programmed to flag one or more dominant business asset(s) from among the business asset(s) of the participating business component(s); and
the identification module is further structured and/or programmed to be selective in that the only changes in the state of the first business asset that are identified are those changes in state associated with the flagged, dominant participating business components and within the scope of the first business scenario.

11. The product of claim 7 wherein the CBM software further comprises a user interface module programmed to receive the CBM, at least in part, by a human user through a user interface.

12. The product of claim 7 wherein the CBM software further comprises a data receiving module programmed to receive the CBM, in at least part, by the receipt of machine readable data corresponding to the CBM by the CBM software.

13. (canceled)

14. A computer system comprising:
a software storage device; and
a set of one or more processing unit(s);
wherein:
the software storage device has stored thereon CBM software and a CBM data set of machine readable data corresponding to a CBM of an enterprise;
the set of processing unit(s) is programmed to run the CBM software from the software storage device; and
the CBM software comprises:
a selection module, programmed to select a first business asset from among the plurality of business assets of the CBM of the enterprise,
an identification module programmed to identify any changes in the state of the first business asset resulting from a set of CBM modeling conditions,
a creation module programmed to create a first state diagram for the first business asset corresponding to the state changes identified by the identification module, and
a presentation module programmed to present the first state diagram in at least one of the two following ways: (i) generating a visual display of at least a portion of the first state diagram for use by a human user, and/or (ii) generating a data set of machine readable data corresponding to the first state diagram data.

15. The system of claim 14 wherein:
the CBM further includes a first business scenario;
the first business scenario defines a set of one or more participating business component(s), from the plurality of business components, corresponding to the business component(s) that participate in the first business scenario; and
the identification module is selective in that the only changes in the state of the first business asset that are identified are those changes in state associated with participating business component(s) and within a scope of the first business scenario.

16. The system of claim 14 wherein:
the selection module is further programmed to select a plurality of selected business assets;
the identification module is further programmed to identify changes in the state of each selected business asset under a set of CBM modeling conditions;
the creation module is further programmed to create a state diagram for each selected business asset respectively corresponding to the state changes for that selected business asset as identified by the identification module;
the presentation module is further programmed to present the state diagrams created by the creation module in at least one of the two following ways: (i) generating a visual display of at least a portion of the first state diagram for use by a human user, and (ii) generating a data set of machine readable data corresponding to the first state diagram data.

17. The system of claim 16 wherein:
the CBM software further includes a flagging module;
the CBM further includes a first business scenario;
the first business scenario defines a set of one or more participating business component(s), from the plurality of business components, corresponding to the business component(s) that participate in the first business scenario;
the flagging module is programmed to flag one or more dominant business asset(s) from among the business asset(s) of the Participating Business Component(s); and
the identification module is further programmed to be selective in that the only changes in the state of the first business asset that are identified are those changes in state associated with the flagged, dominant participating business components and within the scope of the first business scenario.

18. The system of claim 14 wherein the CBM software further comprises a user interface module programmed to receive the CBM, at least in part, by a human user through a user interface.

19. The system of claim 14 wherein the CBM software further comprises a data receiving module programmed to receive the CBM, in at least part, by the receipt of machine readable data corresponding to the CBM by the CBM software.
